(19) United States
(12) Patent Application Publication
(10) Pub. No.: US 2003/0179692 A1
(43) Pub. Date: Sep. 25, 2003

(54) Storage medium

(76) Inventor: Yoshitaka Ohotomo, Fujisawa-Shi (JP)

Correspondence Address: Richard P. Berg, LADAS & PARRY, Suite 2100, 5670 Wilshire Boulevard, Los Angeles, CA, 90036-5679, US

(21) Appl. No.: 10/102,447

(22) Filed: Mar. 19, 2002

(51) Int. Cl. G11B 3/70; G11B 5/84; G11B 7/26

(52) U.S. Cl. 369/280

(57) ABSTRACT

Disc-shaped storage medium provided with identification means to distinguish CD from the other storage medium such as CD-ROM, wherein the identification means comprise raised letters, depressions, projections or a selective combination of thereof formed on a top surface of a substrate so as to be sensed as user touch them with the finger tip. More specifically, the disc-shaped storage medium provided with identification means to distinguish CD from the other storage medium such as CD-ROM, wherein the identification means comprise raised letters, depressions, projections or a selective combination of thereof formed on the top surface of the substrate in the vicinity of its central opening and/or in the vicinity of an outer peripheral edge of the substrate. Particularly, the disc-shaped storage medium provided with the identification means to distinguish CD from the other storage medium such as CD-ROM wherein the storage medium is provided on the top surface of the substrate closely adjacent to an inner peripheral edge of the central opening and/or closely adjacent to the outer peripheral edge with the identification means in the form of raised letters, depressions, projections or a selective combination of them so that at least a part of user's finger tip may come in contact with the identification means provided closely adjacent to the inner peripheral edge of the central opening and/or the outer peripheral edge of the substrate as the user inserts the finger tip into the central opening and/or the user touch the outer peripheral edge of the substrate with the finger tip.

### BACKGROUND OF THE INVENTION

1. Technical Field of the Invention

The present invention relates to storage medium such as CD, CD-ROM used for various apparatus such as audio system and PC.

2. Description of the Related Art

Recent advance of the information technique has made use of the storage medium such as CD and CD-ROM inseparable from daily life. However, these various types of the storage medium are necessarily similar one to another in shape as well as in external appearance for the various reasons such as efficiency for production and convenience for use. In consequence, it is difficult to distinguish one from another and this may raise serious problems such as misuse. More specifically, if incompatible storage medium is carelessly inserted into apparatus such as ordinary audio player, portable player, DVD player, home game apparatus or PC, e.g., for the purpose of play-back, excessively high sound volume may cause disorder of listener's ears or damage of the speaker. While instructions or notes have usually inscribed on the disc face to avoid the misuse, such precautionary measure has not functioned as expected. For example, CD-ROM bears on its face an instruction “This disc is CD-ROM. Never try to play back this disc in ordinary audio player, DVD player, home game apparatus. There is anxiety that excessively high sound volume might cause a serious disorder of the listener's ears or damage of the speaker”. However, such instructions inscribed on CD-ROM's face are too small to be read by a weak-sighted or visually handicapped user, so it is difficult or impossible for such user not only to distinguish CD from the other storage medium such as CD-ROM, CD-W, DVD or DVD-RW but also, in an extreme case, to distinguish the top surface from the bottom surface of the same disc. The letters in such inscription are too small to be properly read and to distinguish the CD from the other storage medium even by a normal-sighted user.

So far as the disc-shaped storage medium is concerned, CD and the other storage medium such as CD-ROM are basically identical or similar to one another in size as well as external shape and it is difficult, in this aspect also, to distinguish CD from the other storage medium such CD-ROM. CD-ROM, CD-R, CD-RW, DVD, DVD-R or DVD-RW can not be played back unless the play-back apparatus is used with the apparatus predetermined for each particular type of the storage medium. Should the user carelessly insert a disc into the incompatible play-back apparatus and the expected play-back is not obtained, it is apprehended that the user might attempt to turn up volume or subsequently use CD at this turned up volume. In view of the fact that the audio system has recently come into general use to play back music, such apprehension also progressively increases. In the present situation that the storage medium such as CD or CD-ROM is essential in daily life for the purpose of enjoying music or acquisition of various information, there is a demand for the effective measure to avoid the risk that the weak-sighted or visually handicapped user can not properly distinguish CD from the other storage medium such as CD-ROM and may sometimes carelessly insert the storage medium, for example, CD-ROM into the apparatus exclusively used with CD. Furthermore, in the present situation that the storage medium, for example, CD-ROM similar to CD in shape as well as in external appearance is usually used with the apparatus such as PC, there is a serious demand for consideration of the visually handicapped user.

In view of the problems as have been described above, it is a principal object of the present invention to provide a storage medium enabling the weak-sighted or visually handicapped user to distinguish CD from the other storage medium such as CD-ROM and particularly to provide a storage medium enabling such user to easily identify the types of storage medium at least by tactual sense.

### SUMMARY OF THE INVENTION

The disc-shaped storage medium including CD and CD-R is usually taken out from its case by holding the storage medium between the forefinger inserted into the central opening of the substrate and the thumb placed against the outer peripheral edge of the substrate. Therefore, the thumb necessarily comes in contact with the outer peripheral edge of the substrate and the finger tip (usually of the forefinger) is apt to come in contact with the face of the substrate. Taking account of this, the face and/or the outer peripheral edge of the substrate may be provided with the identification means to assist the visually handicapped user to sense the identification means by tactual sense and thereby to distinguish CD from the other storage medium such as CD-ROM.

While the location of the identification means is basically not specified so far as the identification means are provided on the face of the substrate, it is preferred to provide the identification means on the top surface of the substrate in the vicinity of its central opening and/or in the vicinity of the outer peripheral edge of the substrate. This is for the reason that, in actual use of the storage medium, the user's finger tip being inserted into the central opening is apt to come in contact with the identification means and similarly the user's finger tip placed against the outer peripheral edge is apt to come in contact with the identification means. In this way, the presence of the identification means is easily sensed.

A transparent region extending around the central opening ensures a well defined space desired for formation of the identification means containing important information such as instruction. In this way, the entire content thereof can be easily and accurately recognized as the finger tip comes in contact with this region. The presence of the identification enables the user to identify the top and bottom surfaces of the storage medium.

The storage medium is provided on the top surface of the substrate closely adjacent to an inner peripheral edge of the central opening and/or closely adjacent to the outer peripheral edge with the identification means so that at least a part of user's finger tip may come in contact with the identification means provided closely adjacent to the inner peripheral edge of the central opening and/or the outer peripheral edge of the substrate as the user inserts the finger tip into the central opening and/or the user touch the outer peripheral edge of the substrate with the finger tip.

The identification means comprise raised letters, depressions, projections or a selective combination of them. The identification means may be formed integrally with the top surface and/or the outer peripheral edge of the substrate or may be realized in the form of a label bearing thereon the identification means and bonded to the top surface and/or the outer peripheral edge of the substrate. Elements constituting the identification means provided on the top surface and/or the outer peripheral edge of the substrate are not particularly specified. If the identification means are constituted by the raised letters, the visually handicapped user can recognize the content of inscription by touching the raised letters with the finger tip. Obviously, the raised letters are projections formed on the top surface of the substrate in accordance with a predetermined rule. Particular shapes, constructions and sizes of the depressions and the projections constituting the identification means are optional so long as these elements are easily and accurately sensed by contact with the user's finger tip or user's skin. These elements may be of band-like type, linear type, continuous type or discrete type.

The depressions or the projections other than the raised letters are individually unable to have specified meanings and therefore the specified means must be previously assigned to the individual depressions or projections or to combinations thereof. For example, it must be previously defined that the identification storage medium having depressions or projections or the combination thereof in accordance with a predetermined arrangement or configuration should be understood to be CD. The visually handicapped user senses such depressions or projections and thereby confirms that the storage medium is CD. Similarly, it is also possible to identify the particular type of the storage medium by sensing the identification means of the predetermined arrangement or configuration.

While the storage medium such as CD generally has the disc-shaped substrate, the shape of the substrate is not limited to disc-shape and may have the other shapes such as rectangular name card-like shape (not shown). Since the shape of the substrate is not specified, the identification means according to the invention may be provided also on the storage medium comprising a flat substrate of any other shape. The types of the storage medium to which the present invention is applicable are also not specified and the present invention is applicable in addition to CD, CD-ROM, CD-R, CD-RW, DVD, DVD-R and DVD-RW, also to still other types of storage medium having the other functions but being similar to the above enumerated in shape as well as in configuration. The present invention is applicable not only to these existing types of storage medium but also to those which will be developed in future as new products.

### BRIEF DESCRIPTION OF THE DRAWINGS

FIG. 1 is a plan view showing the storage medium provided in the vicinity of its central opening with identification means;

FIG. 2 is a plan view showing the storage medium provided in the vicinity of its outer peripheral edge with identification means;

FIG. 3 is a plan view showing an embodiment of the storage medium provided along its outer peripheral edge with identification means;

FIG. 4 is a plan view showing another embodiment of the storage medium provided along its outer peripheral edge with identification means;

FIG. 5 is a plan view showing still another embodiment of the storage medium provided along its outer peripheral edge with identification means;

FIG. 6 is a perspective view showing the storage medium of FIG. 5;

FIG. 7 is a perspective view showing the storage medium provided with identification means in the form of grooves;

FIG. 8 is a side view showing the storage medium of FIG. 7;

FIG. 9 is a perspective view showing the storage medium provided with identification means in the form of ridges;

FIG. 10 is a side view showing the storage medium of FIG. 9;

FIG. 11 is a plan view showing the storage medium provided with an embodiment of the label carrying identification means and bonded thereto;

FIG. 12 is a plan view showing the storage medium provided with another embodiment of the label carrying identification means and this label itself before it is bonded to the storage medium;

FIG. 13 is a plan view showing the storage medium provided in the vicinity of its central opening as well as its outer peripheral edge with identification means; and

### DETAILED DESCRIPTION OF THE PREFERRED EMBODIMENTS

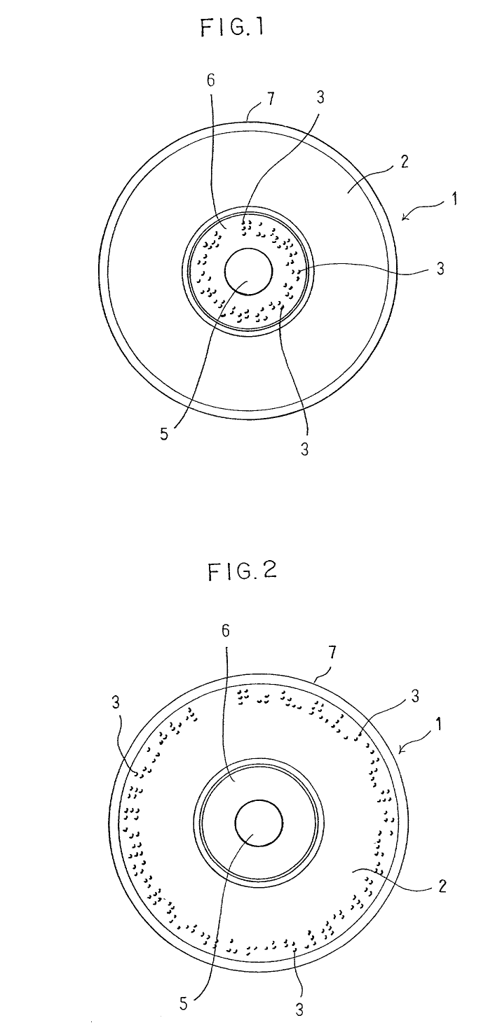

Substrate 2 for storage medium 1 shown in FIG. 1 is a disc-like flat plate which is formed on its top surface immediately outside its central opening with a rugged region serving as identification means 3 to distinguish CD from the other types of storage medium such as CD-ROM, CD-RW, DVD, DVD-R or DVD-RW. (referred to hereinafter simply as “The storage medium other than CD such as CD-ROM”). While the embodiment shown in FIG. 1 has the identification means 3 formed in a transparent region 6 adjacent the central opening, it is also possible the identification means 3 outside this transparent region 6 (not shown).

The substrate 2 for the storage medium 1 shown in FIG. 2 is formed in the vicinity of its outer peripheral edge 7 with the rugged region serving as the identification means 3 to distinguish CD from the other types of storage medium such as CD-ROM. More specifically, the identification means 3 comprise raised letters arranged on a substantially belt-like complete circle concentric with the central opening 5. A visually handicapped user may touch the raised letters 3 with the finger to confirm instructions or the other represented by the raised letters 3. The identification means (raised letter) 3 are formed in the vicinity of the central opening 5 and/or in the vicinity of the outer peripheral edge 7, so it is easy for the visually handicapped user to touch the identification means 3 and to perceive the presence thereof. It is also possible to combine the identification means 3 in the form of the rugged region with regular letters (not shown) taking account of the weak-sighted user.

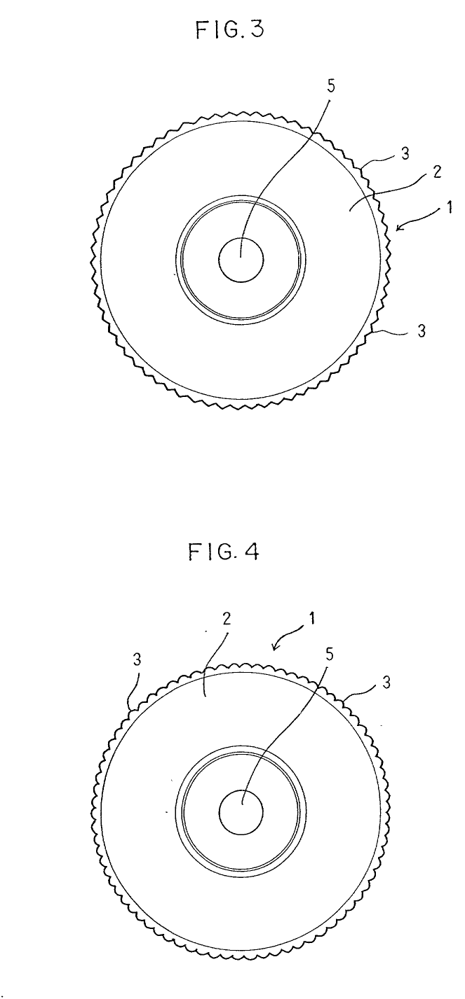

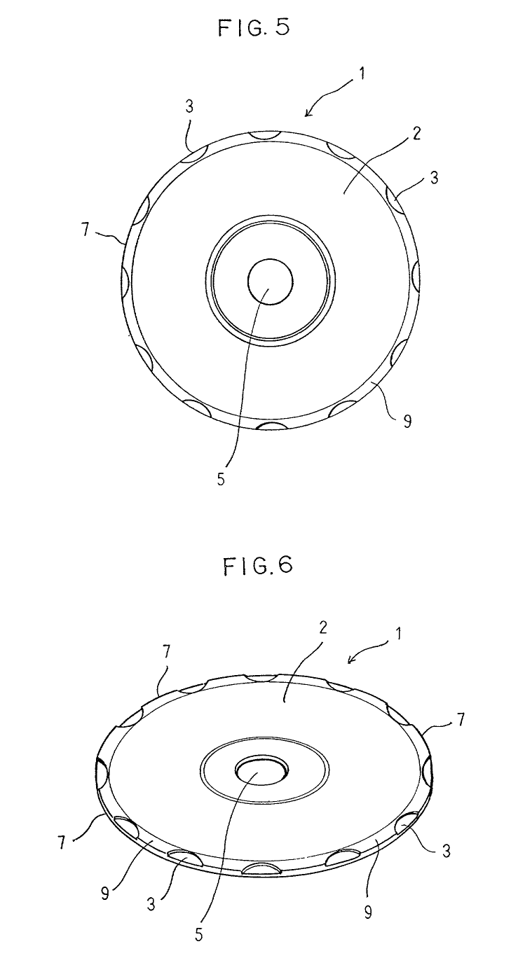

The storage medium 1 shown in FIGS. 3 and 4 is provided along the outer peripheral edge of the substrate 2 with the identification means 3 in the form of depressions or projections of combination thereof. While these depressions and/or projections are illustrated to be formed along the outer peripheral edge of the substrate substantially over its entire circumference, it is also possible to form them along a part of the outer peripheral edge. However, it is better to form these depressions and/or projections over the entire outer peripheral edge because the presence of the identification means 3 can be reliably sensed as soon as the storage medium 1 is touched with the finger by the visually handicapped user. The storage medium 1 shown in FIGS. 5 and 6 is provided not only on the top surface but also along the outer peripheral edge of the substrate 2 with the identification means 3 in the form of notches. These notches 3 serving the identification means are present along the outer peripheral edge 7 as well as on the top surface 9, so the top and bottom surfaces of the substrate 2 and, therefore, of the storage medium 1 can be easily identified as the user touches any one of these notches 3.

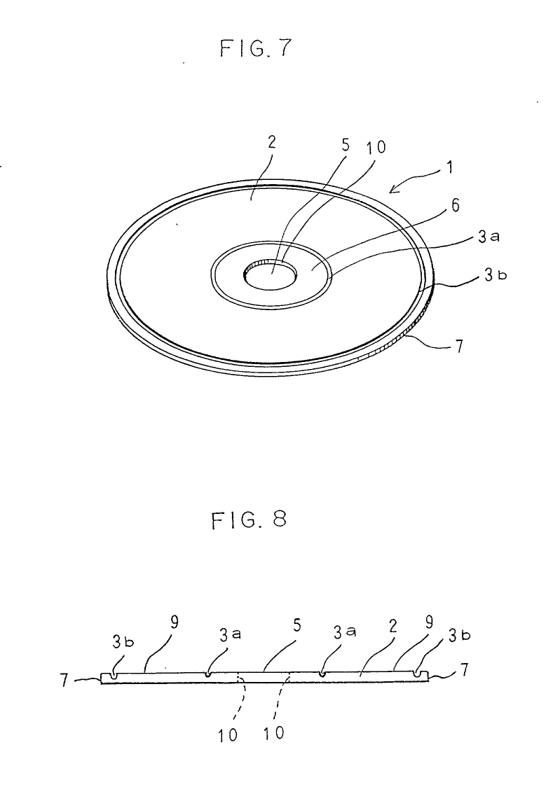

The storage medium 1 shown in FIGS. 7 and 8 is provided on the top surface 9 of the substrate 2 with the identification means 3 in the form of two concentric circular grooves. Of these two circular grooves 3, the inner groove 3a is formed in the transparent regions 6 extending outside the central opening 5 and the outer groove 3b is formed in the vicinity of the outer peripheral edge 7.

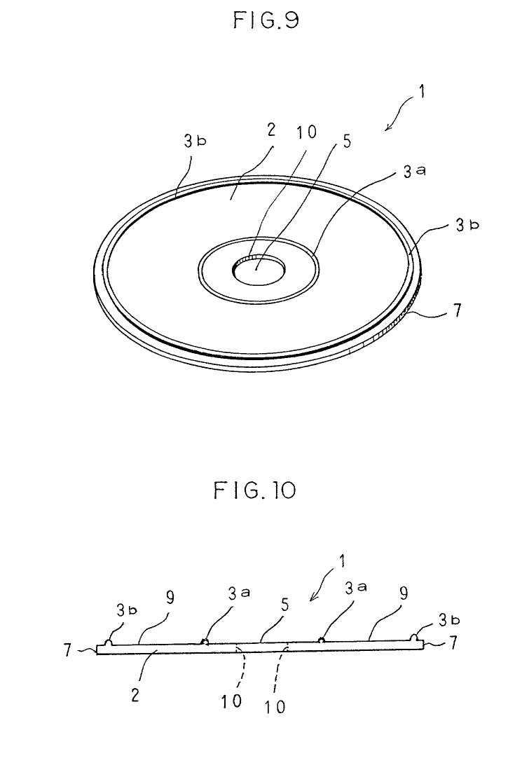

The storage medium 1 shown in FIGS. 9 and 10 is provided on the top surface of the substrate 2 with the identification means 3 in the form of ridges. Specifically, the substrate 2 is formed on its top surface 9 with these ridges describing two concentric circles, of which the inner ridge 3a is formed in the transparent region 6 extending outside the central opening 5 and the outer ridge 3b is formed in the vicinity of the outer peripheral edge 7.

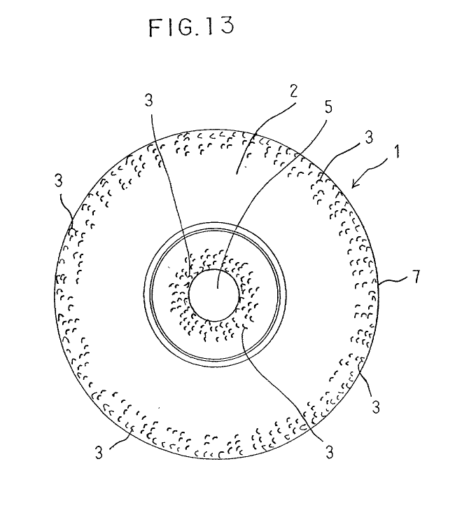

The storage medium 1 shown in FIG. 13 is provided on the top surface 9 of the substrate closely adjacent to an inner peripheral edge 10 of the central opening 5 and/or closely adjacent to the outer peripheral edge 7 with the identification means 3 in the form of rugged regions. While the concept “closely adjacent to” is included in the concept “in the vicinity of”, expression “closely adjacent to” means that these identification lie further near to the inner peripheral edge 10 of the central opening or the outer peripheral edge 7 of the substrate 2. Though the configuration of the rugged regions serving as the identification means 3 are not specified, these regions are preferably formed by raised letters. The identification means 3 lying closely adjacent to the central opening 5 and/or the outer peripheral edge 7 ensure that at least a part of user's finger (not shown) reliably comes in contact with the identification means 3 as user inserts the finer tip into the central opening 5 or user's finger touches the outer peripheral edge 7. Thereupon, the presence of the identification means 3 is reliably sensed. Particularly if the respective identification means 3 comprise raised letters, the visually handicapped user is very sensitive to detect the presence of the identification means 3 merely by touching a part of the raised letters (projection) and able to confirm the predetermined contents of instruction by enlarging the range of contact with the other raised letters. The respective identification means (raised letters) formed closely adjacent to the inner peripheral edge 10 of the central opening 5 and closely adjacent to the outer peripheral edge 7 of the substrate 2 are preferably formed along the substantially entire circumferences of these inner peripheral edge 10 and the outer peripheral edge 7.

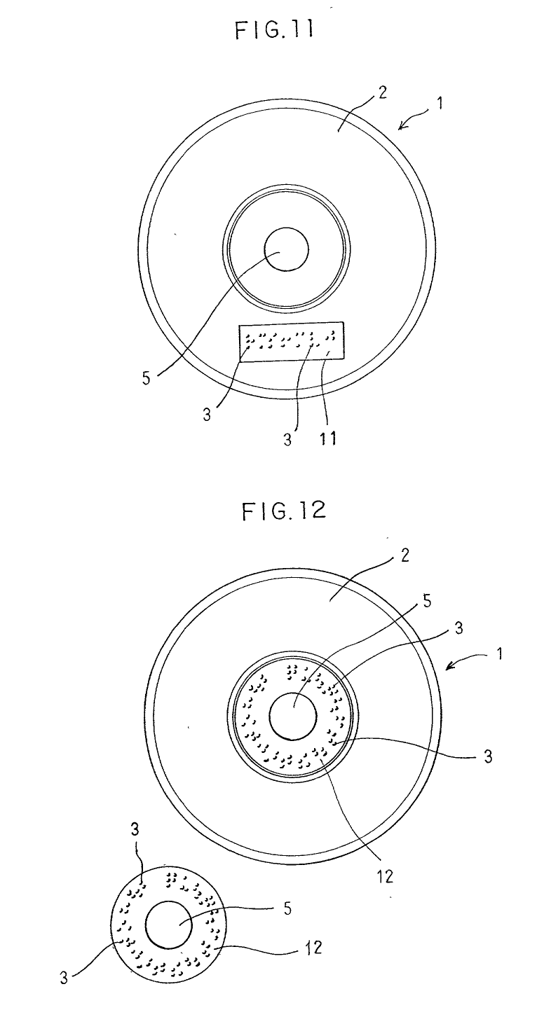

The identification means 3 have been described and illustrated to be formed integrally with the top surface of the substrate 2, the manner in which the present invention is implemented is not limited to this. The storage medium 1 shown in FIGS. 11 and 12 includes labels 11, 12 carrying raised letters 3 bonded to the top surface of the substrate 2. In this case, it is possible to provide the existing storage medium 1 with the desired identification means 3 merely by bonding one or more of such label 11, 12 to the top surface of the substrate 2. Except the storage medium 1 shown in FIG. 11, every storage medium 1 as has been described is provided with the identification means 3 formed outside the central opening 6 so as to be substantially symmetrical and uniform about the central opening. Therefore, it is not apprehended that the identification means 3 might affect rotation of the storage medium 1.

It is possible to use the identification means 3 such as raised letters having a color distinguished from the base color of the substrate. It is also possible to coat the identification means 3 with fluorescent coating so to facilitate the identification means visually recognized even by the visually handicapped user.

What is claimed is:

1. Disc-shaped storage medium provided with identification means to distinguish CD from the other storage medium such as CD-ROM, wherein said identification means comprise raised letters, depressions, projections or a selective combination of thereof formed on a top surface of a substrate so as to be sensed as user touch them with the finger tip.

2. Disc-shaped storage medium provided with identification means to distinguish CD from the other storage medium such as CD-ROM, wherein said identification means comprise raised letters, depressions, projections or a selective combination of thereof formed on a top surface of a substrate in the vicinity of its central opening and/or in the vicinity of an outer peripheral edge of said substrate.

3. The disc-shaped storage medium according to claim 2, wherein said identification means are formed in a transparent region extending outside on the top surface of the substrate.

4. The disc-shaped storage medium provided with identification means to distinguish CD from the other storage medium such as CD-ROM according to claim 1, wherein said storage medium is provided on the top surface of the substrate closely adjacent to an inner peripheral edge of the central opening and/or closely adjacent to the outer peripheral edge with the identification means in the form of raised letters, depressions, projections or a selective combination of them so that at least a part of user's finger tip may come in contact with the identification means provided closely adjacent to the inner peripheral edge of the central opening and/or the outer peripheral edge of the substrate as the user inserts the finger tip into the central opening and/or the user touch the outer peripheral edge of the substrate with the finger tip.

5. The disc-shaped storage medium according to claim 1, wherein said identification means are along the outer peripheral edge of the substrate over its entire circumference.

6. The disc-shaped storage medium according to claim 1, wherein said identification means comprise one or more ridges and/or grooves formed on the top surface of the substrate so as to describe concentric circles.

7. The disc-shaped storage medium according to claim 1, wherein said identification means comprising, for example, raised letters have a color different from a base color.

8. The disc-shaped storage medium according to claim 1, wherein said identification means comprising, for example, raised letters have a color different from the base color and exhibit fluorescence.

9. The disc-shaped storage medium according to claim 1, wherein said identification means comprising, for example, raised letters are carried on a seal adapted to be bonded to the top surface of the substrate.

10. The disc-shaped storage medium according to claim 1, wherein the instruction or the like represented by raised letters serving as the identification means corresponds to the official languages of the country in which the storage medium is used.

11. Flat plate-shaped storage medium provided on a top surface and/or along an outer peripheral edge of a substrate with identification means to distinguish CD from CD-ROM etc. other than CD.

12. The storage medium according to claim 11, wherein said substrate is disc-shaped.
